(19) United States
(12) Patent Application Publication
(10) Pub. No.: US 2012/0187931 A1
(43) Pub. Date: Jul. 26, 2012

(54) Power Supply Control Circuit and Power Supply Circuit

(75) Inventor: Masahiro Maruki, Gunma-ken (JP)

(73) Assignee: ON Semiconductor Trading, Ltd., Hamilton (BM)

(21) Appl. No.: 13/191,955

(22) Filed: Jul. 27, 2011

(30) Foreign Application Priority Data
Jul. 29, 2010 (JP) 2010-170780

(51) Int. Cl. G05F 1/10

(52) U.S. Cl. 323/282

(57) ABSTRACT

A power supply control circuit comprising: a first control circuit configured to control on/off of a transistor, whose input electrode is applied with an input voltage, based on a feedback voltage so that an output voltage at a target level is generated from the input voltage to be applied to a load, the feedback voltage being in accordance with a reference voltage and the output voltage; and a second control circuit configured to control a feedback voltage generation circuit so that the output voltage rises with increase in load current flowing through the load, the feedback voltage generation circuit configured to generate the feedback voltage.

### CROSS-REFERENCE TO RELATED APPLICATION

This application claims the benefit of priority to Japanese Patent Application No. 2010-170780, filed Jul. 29, 2010, of which full contents are incorporated herein by reference.

### BACKGROUND OF THE INVENTION

1. Field of the Invention

The present invention relates to a power supply control circuit and a power supply circuit.

2. Description of the Related Art

A switching power supply circuit is known as a circuit to generate an output voltage at a target level from an input voltage (See Japanese Patent Laid-Open Publication No. 2006-174630, for example).

The output voltage generated by the switching power supply circuit is generally applied to a load through wiring having a small resistance value and the like. Thus, the voltage applied to the load does not fall largely from the target level even if the load current is large. However, in the case where the long wiring is employed and the resistance value of the wiring increases, when a large load current is supplied to the load from the power supply circuit, the level of the voltage applied to the load might largely fall from the target level.

### SUMMARY OF THE INVENTION

A power supply control circuit according to an aspect of the present invention, includes: a first control circuit configured to control on/off of a transistor, whose input electrode is applied with an input voltage, based on a feedback voltage so that an output voltage at a target level is generated from the input voltage to be applied to a load, the feedback voltage being in accordance with a reference voltage and the output voltage; and a second control circuit configured to control a feedback voltage generation circuit so that the output voltage rises with increase in load current flowing through the load, the feedback voltage generation circuit configured to generate the feedback voltage.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating a configuration of a power supply circuit 10 according to an embodiment of the present invention; and

FIG. 2 is a diagram illustrating an operation of a power supply circuit 10.

### DETAILED DESCRIPTION OF THE INVENTION

At least the following details will become apparent from descriptions of this specification and of the accompanying drawings.

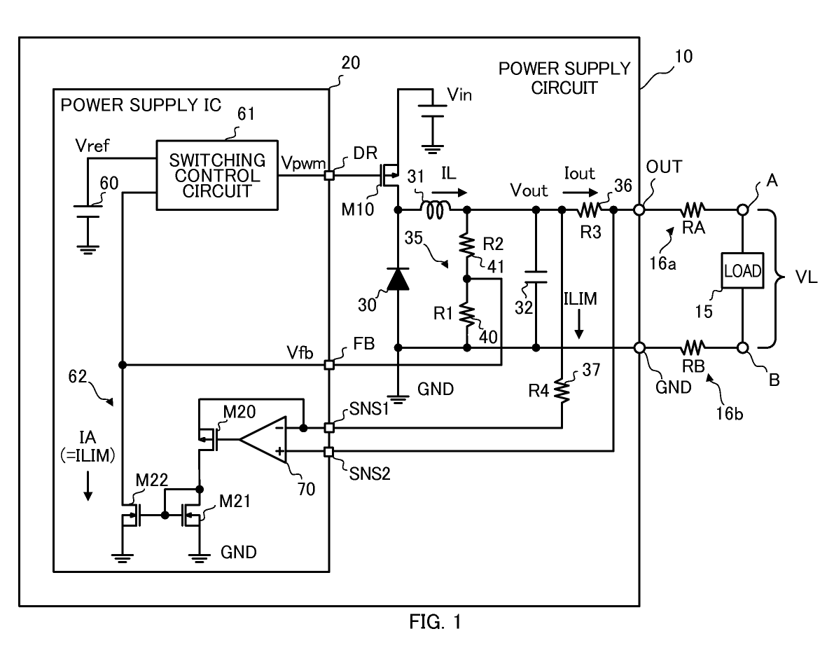

FIG. 1 is a diagram illustrating a configuration of a power supply circuit 10 according to an embodiment of the present invention. The power supply circuit 10 is a so-called diode-rectification type switching power supply circuit, and is configured to output an output voltage Vout at a target level, which is generated from an input voltage Vin, to a load 15 connected through cables 16a and 16b. The power supply circuit 10 raises the output voltage Vout with increase in load current Iout flowing through the load 15 so that a voltage VL applied to the load 15 becomes constant.

The load 15 is a portable electronic device, for example, and is configured to operate using the voltage VL, which is generated between a positive-side terminal A and a negative-side terminal B of the load 15, as a power supply voltage.

The cable 16a connects between a terminal OUT of the power supply circuit 10, applied with the output voltage Vout, and the terminal A of the load 15. In FIG. 1, a resistor RA is illustrated between the terminal OUT and the terminal A, but the resistor RA is resistance of the cable 16a between the terminal OUT and the terminal A, and is illustrated for convenience.

The cable 16b connects between a terminal GND of the power supply circuit 10 and the terminal B of the load 15. A resistor RB illustrated between the terminal GND and the terminal B is resistance of the cable 16b similarly to the resistor RA. Therefore, the voltage VL, which is generated between the terminals A and B and applied to the load 15, is expressed by the following expression (1), and the voltage VL falls with increase in the load current Iout:

VL=Vout−(RA+RB)×Iout (1)

In an embodiment of the present invention, it is assumed that a resistor 36 is selected so that the resistance value of the resistor 36, which is disposed between a capacitor 32 and the terminal OUT, is sufficiently smaller than resistance values of the cables 16a and 16b.

The power supply circuit 10 includes a power supply IC (Intergrated Circuit) 20, a PMOS transistor M10, a diode 30, an inductor 31, the capacitor 32, a feedback voltage generation circuit 35, the resistor 36 and a resistor 37.

The power supply IC 20 (power supply control circuit) is configured to control on/off of the PMOS transistor M10 according to a feedback voltage Vfb, which is in according with the output voltage Vout, and/or the load current Iout. The power supply IC 20 will be described later in detail.

The PMOS transistor M10 is a power transistor configured to drive the load 15, and has a source electrode applied with the input voltage Vin, a drain electrode connected to the diode 30, and a gate electrode connected to a terminal DR of the power supply IC 20. Since a voltage according to the input voltage Vin is outputted from the drain electrode, the source electrode of the PMOS transistor M10 results in an input electrode, while the drain electrode results in an output electrode.

The inductor 31 and the capacitor 32 makes up a low pass filter configured to attenuate a high frequency component of the voltage of the drain electrode in the PMOS transistor M10. Thus, in the capacitor 32, the DC output voltage Vout is generated. A current IL flowing through the inductor 31 contains a so-called ripple current, and the ripple current flows to the ground GND through the capacitor 32. Therefore, the current IL, in which high-frequency noise component is suppressed, is supplied to the load 15 as the load current Iout.

The feedback voltage generation circuit 35 is a circuit configured to generate a feedback voltage Vfb that in accordance with the output voltage Vout, and include resistors 40 and 41. The respective resistance values of the resistors 40 and 41 are referred to as R1 and R2, respectively.

The resistor 36 (detection resistor) is a detection resistor provided between a node, which is connected to the inductor 31 and the capacitor 32, and the terminal OUT, and the resistor is configured to detect the load current Iout. One end of the resistor 36 is connected to the capacitor 32, and the other end thereof is connected to a terminal SNS2 of the power supply IC 20. As described above, since the ripple current contained in the current IL flows to the ground GND through the capacitor 32, the load current Iout, in which a noise component is suppressed, is detected in the resistor 36. The resistance value of the resistor 36 is referred to as a resistance value R3.

The resistor 37 has one end connected to one end of the resistor 36, and the other end connected to a terminal SNS1 of the power supply IC 20. Though details will be described later, in an embodiment of the present invention, an operational amplifier 70 is configured to control a PMOS transistor M20 so that the voltage at the terminal SNS1 becomes equal to the voltage at the terminal SNS2. Thus, in the resistor 37, a current ILIM, which changes similarly to the load current Iout, is generated.

The power supply IC 20 is an integrated circuit including a reference voltage generation circuit 60, a switching control circuit 61, an output voltage adjustment circuit 62, and terminals DR, FB, SNS1, and SNS2.

The reference voltage generation circuit 60 is configured to generate a reference voltage Vref with accuracy such as a bandgap voltage, for example.

The switching control circuit 61 (first control circuit) is configured to perform switching for the PMOS transistor M10 with a PWM (Pulse Width Modulation) signal Vpwm so that the feedback voltage Vfb inputted through the terminal FB becomes equal to the reference voltage Vref. The switching control circuit 61 is configured to change the duty ratio of the PWM signal Vpwm so that a time period, during which the PMOS transistor M10 is ON, becomes shorter if the feedback voltage Vfb is higher than the reference voltage Vref, for example. On the other hand, the switching control circuit 61 is configured to change the duty ratio of the PWM signal Vpwm so that a time period, during which the PMOS transistor M10 is ON, becomes longer if the feedback voltage Vfb is lower than the reference voltage Vref.

Here, for example, if an NMOS transistor 22 is turned off and a current flowing through the NMOS transistor 22 is zero, the feedback voltage Vfb=Vout×(R1/(R1+R2)), and the output voltage Vout, as expressed by an expression (2), is generated:

Vout=(1+R2/R1)×Vref (2)

In an embodiment of the present invention, the output voltage Vout in the case where the NMOS transistor 22 is OFF, that is, the output voltage Vout in the case where the output voltage Vout is determined based on a voltage division ratio of the resistance values R1 and R2, as expressed by the expression (2), is assumed to be the output voltage Vout at a target level.

The output voltage adjustment circuit 62 (second control circuit) is configured to control the feedback voltage generation circuit 35 so that the output voltage Vout rises with increase in the load current Iout. The output voltage adjustment circuit 62 includes the operational amplifier 70, the PMOS transistor M20, and the NMOS transistors M21 and M22. The PMOS transistor M20 and the NMOS transistor M21 correspond to a current generation circuit.

An inverting input terminal of the operational amplifier 70 is connected to the terminal SNS1, and the non-inverting input terminal thereof is connected to the terminal SNS2. A gate and a source of the PMOS transistor M20 are connected to the output terminal and the inverting input terminal of the operational amplifier 70, respectively. Thus, the operational amplifier 70 is configured to control a gate voltage of the PMOS transistor M20 so that the voltage at the terminal SNS1 becomes equal to the voltage at the terminal SNS2. Since one end of the resistor 37 is connected to one end of the resistor 36, the voltage across (between both ends of) the resistor 36 is equal to the voltage across the resistor 37.

Therefore, the current ILIM flowing through the resistor 36 is expressed by an expression (3):

ILIM=(R3/R4)×Iout (3)

Since the currents flowing through the inverting input terminal and the non-inverting input terminal of the operational amplifier 70 are substantially zero, the current ILIM is supplied to the PMOS transistor M20.

The current ILIM from the PMOS transistor M20 is supplied to the diode-connected NMOS transistor M21. The NMOS transistors M21 and M22 make up such a current mirror circuit that the currents respectively flowing through the NMOS transistors M21 and M22 are equal to each other. Thus, a current IA, which is equal to the current ILIM, flows through the NMOS transistor M22.

A drain electrode of the NMOS transistor M22 is connected to the resistor 40 and the resistor 41. Thus, if the NMOS transistor M22 is turned on and the current IA flows, the output voltage Vout is expressed by an expression (4):

Vout=(1+R2/R1)×Vref+R2×IA (4)

In an embodiment of the present invention, the current IA is equal to the current ILIM, which results in the output voltage Vout expressed by an expression (5):

Vout=(1+R2/R1)×Vref+R2×(R3/R4)×Iout (5)

Therefore, the voltage adjustment circuit 62 raises the output voltage Vout from the target level with increase in the load current Iout, as expressed by the expression (5).

==Operation of power supply circuit 10==

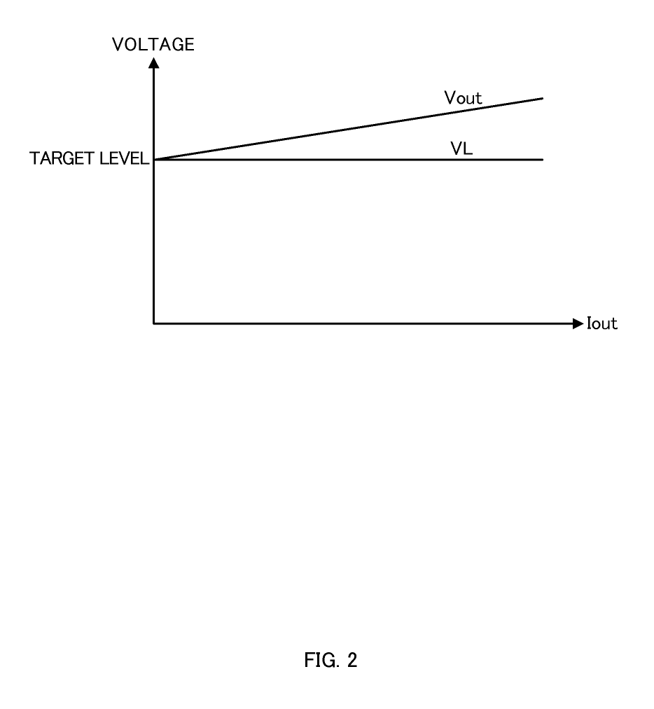

Here, an example of an operation of the power supply circuit 10 in the case where the load current IL1 increases from zero will be described, referring to FIG. 2. In an embodiment of the present invention, it is assumed that the value of “R2×(R3/R4)” in the expression (5) is determined so that the voltage VL generated in the load 15 does not change in level from the target level. Specifically, a design is assumed to be such that the value of “R2×(R3/R4)”, which is a coefficient of a term changing with the load current Iout in the expression (5), becomes equal to “RA+RB”, which is a coefficient of a term changing with the load current Iout in the expression (1). Also, in an embodiment of the present invention, the resistance value RB of the cable 16b on the ground GND side is assumed to be sufficiently smaller than the resistance value RA of the cable 16a which is applied with the output voltage Vout, for example. Thus, here, regardless of the load current Iout, the voltage at the terminal B is substantially zero.

First, in the case where the load current Iout is zero, the current IA outputted from the NMOS transistor M22 is zero. Thus, in this case, the output voltage Vout at the target level is generated as described above. Also, in the case where the load current Iout is zero, since voltage drop in the resistors RA and RB of the cables 16a and 16b does not occur, the level of the voltage VL applied to the load 15 also results in the target level.

Subsequently, in the case where the load current Iout increases from zero, the voltage drop in the cables 16a and 16b results in (RA+RB)×Iout. In an embodiment of the present invention, however, the output voltage Vout rises only by R2×(R3/R4)×Iout, that is, (RA+RB)×Iout. Therefore, even if voltage drop occurs in the cables 16a and 16b, the level of the voltage VL applied to the load 15 results in the target level.

As such, in an embodiment of the present invention, even in the case where the load current Iout increases, a drop in the voltage VL can be suppressed.

Hereinabove, the power supply circuit 10 according to an embodiment has been described. The power supply circuit 10 raises the output voltage Vout in the case where the load current Iout increases. Thus, for example, even in the case where the voltage drop in the cable 16a is large, a drop in the voltage VL applied to the load 15 can be suppressed. As a result, the voltage VL can fall within a desired voltage range, for example, and thus, occurrence of malfunction or the like of the load 15 can be prevented.

Further, the resistor 36 is disposed closer to the load 15 as compared with the node connected to the inductor 31 and the capacitor 32. Thus, the voltage adjustment circuit 62 can change the output voltage Vout with accuracy on the basis of the load current Iout in which a noise component is suppressed.

Further, the current flowing through the feedback voltage generation circuit 35 is controlled so as to raise the output voltage Vout in an embodiment of the present invention, but, for example, a transistor may be provided in parallel with the resistor 40, thereby changing on resistance of the transistor. However, in general, the on resistance of the transistor is fluctuated, and therefore, it is difficult to control the output voltage Vout with accuracy. On the other hand, the current IA flowing through the NMOS transistor M22 can be controlled with accuracy, as long as the NMOS transistors M21 and M22 operate as a current mirror circuit. Thus, in an embodiment of the present invention, the output voltage Vout can be changed with accuracy.

Further, the operational amplifier 70 is configured to control the current ILIM flowing through the resistor 37 so that the voltage at the terminal SNS1 and the voltage at the terminal SNS2 become equal to each other. Also, since the current IA, which is equal to the current ILIM, flows through the feedback voltage generation circuit 35, the output voltage Vout changes with the product of the load current Iout and “R2×(R3/R4)”. As such, in an embodiment of the present invention, a variation range of the output voltage Vout with respect to the load current Iout can be set freely by adjusting the value of “R2×(R3/R4)”.

The power supply circuit 10 is a diode rectification type power supply circuit, but it may be asynchronous rectification type power supply circuit, for example.

Further, in an embodiment of the present invention, it is assumed that the resistor 36 is selected so that the resistance value of the resistor 36 becomes sufficiently smaller than the resistance values of the cables 16a and 16b, but the resistance value of the resistor 36 may be considerably large. In this case, since the expression (1) is given by VL=Vout−(RA+RB+R3)×Iout, the drop in the voltage VL can be suppressed with accuracy by making the value of “R2×(R3/R4)” equal to the value of “RA+RB+R3”.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. A power supply control circuit comprising:
a first control circuit configured to control on/off of a transistor, whose input electrode is applied with an input voltage, based on a feedback voltage so that an output voltage at a target level is generated from the input voltage to be applied to a load, the feedback voltage being in accordance with a reference voltage and the output voltage; and
a second control circuit configured to control a feedback voltage generation circuit so that the output voltage rises with increase in load current flowing through the load, the feedback voltage generation circuit configured to generate the feedback voltage.

2. The power supply control circuit according to claim 1, wherein
the second control circuit is configured to control the feedback voltage generation circuit so that the output voltage rises with increase in the load current based on a voltage generated in a detection resistor, the detection resistor disposed closer to the load as compared with a connection node between an inductor connected to an output electrode of the transistor and a capacitor connected to the inductor, the detection resistor configured to detect the load current.

3. A power supply circuit configured to generate an output voltage at a target level from an input voltage, comprising:
a transistor whose input electrode is applied with the input voltage;
an inductor having one end connected to an output electrode of the transistor;
a capacitor connected to the other end of the inductor, the capacitor configured to generate the output voltage at the target level;
a detection resistor having one end connected to the other end of the inductor, the detection resistor configured to detect a load current flowing through a load;
a feedback voltage generation circuit configured to generate a feedback voltage, the feedback voltage being in accordance with the output voltage;
a first control circuit configured to control on/off of the transistor so that the output voltage at the target level is generated from the input voltage based on a reference voltage and the feedback voltage; and
a second control circuit configured to control the feedback voltage generation circuit so that the output voltage rises with increase in the load current based on a voltage generated in the detection resistor.

4. The power supply circuit according to claim 3, wherein
the feedback voltage generation circuit includes a voltage dividing circuit configured to output a divided voltage as the feedback voltage, the divided voltage obtained by dividing the output voltage, and wherein
the second control circuit is configured to control a current flowing through the voltage dividing circuit so that the output voltage rises with increase in the load current based on the voltage generated in the detection resistor.

5. The power supply circuit according to claim 4, further comprising:
a resistor having one end connected to the one end of the detection resistor; and
a current generation circuit configured to generate a current flowing through the resistor, wherein
the second control circuit includes:
an operational amplifier configured to control the current generation circuit so that a voltage at the other end of the detection resistor becomes equal to a voltage at the other end of the resistor; and
a current control circuit configured to control the current flowing through the voltage dividing circuit so that the output voltage rises with increase in the current flowing through the resistor.
